(19) United States
(12) Patent Application Publication
(10) Pub. No.: US 2018/0266645 A1
(43) Pub. Date: Sep. 20, 2018

(54) VEHICLE LAMP

(71) Applicant: LG Innotek Co., Ltd., Seoul (KR)

(72) Inventors: JI HOON KIM, Seoul (KR); DONG KYUN KIM, Seoul (KR)

(21) Appl. No.: 15/757,220

(22) PCT Filed: Sep. 1, 2016
(86) PCT No.: PCT/KR2016/009810

§ 371 Date: Mar. 2, 2018

(30) Foreign Application Priority Data
Sep. 3, 2015 (KR) 10-2015-0124709

(51) Int. Cl. F21S 45/43; F21S 45/48

(52) U.S. Cl. CPC F21S 45/43; F21S 45/48

(57) ABSTRACT

An embodiment of the present invention relates to a vehicle lamp structure for removing condensation on a lens part. In particular, provided is a vehicle lamp comprising: a lens part; a light source part separated from the lens part; a bezel part which is adjacent to the light source part and provides a separation space between the lens part and the light source part; and a thermoelectric circulation part which is disposed outside the bezel part and includes a thermoelectric module which comprises a plurality of thermoelectric semiconductor devices and is disposed between a first substrate and a second substrate which face each other, wherein the thermoelectric circulation part enables air, which has passed through a first heat conversion member on the thermoelectric module, to flow into the separation space.

### TECHNICAL FIELD

The present invention relates to a vehicle lamp structure for removing condensation on a lens part.

### BACKGROUND ART

The headlamps of a vehicle are used for illuminating a front of the vehicle when the vehicle is traveling. Light sources are provided inside the headlamps, and light is emitted to an upper portion or a lower portion of the front of the vehicle from light emitted by the light sources.

Due to the heat of the light sources themselves of the headlamps and heat transmitted from an engine of the vehicle, the headlamps are placed in a high temperature environment and a temperature difference with the outside is created, and thus condensation occurs inside the headlamps.

Such a problem of moisture generation inside the headlamp causes a problem of the headlamps malfunctioning and the lowering of the commerciality thereof. Further, although the problem of moisture generation is recognized as an inherent problem in a vehicle headlamp system and various solutions have been proposed, there is still no fundamental solution to this problem.

### DISCLOSURE

### Technical Problem

The present invention is directed to providing a vehicle lamp in which a thermoelectric circulation part including a thermoelectric module is provided on an outer periphery of a lens part and a bezel part, air which has passed through a heat absorbing part is blown at regular intervals to maintain a temperature of a closed space in which the lens part is disposed at a temperature of a dew point and to remove moisture, and thus a condensation phenomenon occurring in the lens part may be eliminated.

### Technical Solution

One aspect of the present invention provides a vehicle lamp including: a lens part; a light source part spaced apart from the lens part; a bezel part which is adjacent to the light source part and provides a separation space between the lens part and the light source part; and a thermoelectric circulation part which is disposed outside the bezel part and includes a thermoelectric module including a plurality of thermoelectric semiconductor devices disposed between a first substrate and a second substrate facing each other, wherein the thermoelectric circulation part enables air, which has passed through a first heat conversion member on the thermoelectric module, to be introduced into the separation space.

### Advantageous Effects

According to embodiments of the present invention, a thermoelectric circulation part including a thermoelectric module is disposed outside a housing of a vehicle lamp, air having a temperature of a dew point or less is guided into a lens part through a heat sink (a first heat conversion member) of a heat absorbing part, and thus humidity inside the lens part can be adjusted by removing water droplets condensed in the heat sink.

Specifically, a separation space between the lens part and a bezel part has a closed structure so that humidity inside the separation space can be adjusted by the thermoelectric circulation part and a condensation phenomenon occurring in the lens part can be efficiently controlled.

Furthermore, heat inside the housing can be discharged to the outside using a heat generating part of the thermoelectric circulation part so that the heat dissipation efficiency of the vehicle lamp can be increased.

### DESCRIPTION OF DRAWINGS

FIG. 1 is a conceptual view showing a side section of a vehicle lamp according to an embodiment of the present invention.

FIG. 2 is an exploded conceptual perspective view showing the vehicle lamp of FIG. 1.

FIG. 3 is a conceptual perspective view showing an operational state of the vehicle lamp of FIG. 2.

FIGS. 4 and 5 are graphs showing embodiments of controlling a blowing module according to an embodiment of the present invention.

FIG. 6 is a cross-sectional view showing a main part of a thermoelectric module according to an embodiment of the present invention applied to the vehicle lamp described above with reference to FIGS. 1 to 3.

FIG. 7 is a view showing an example in which a structure of FIG. 6 is modularized and expanded.

FIG. 8 is a view showing various embodiments of a heat conversion member according to an embodiment of the present invention.

FIG. 9 is a view showing in detail a structure of a first heat conversion member according to the embodiment of the present invention described above with reference to FIG. 8.

FIG. 10 is an enlarged conceptual view of a structure in which one flow path pattern is formed in the first heat conversion member.

FIG. 11 is a view showing a shape of a thermoelectric semiconductor device according to another embodiment of the present invention.

FIGS. 12 to 14 are views showing examples in which the structure of the thermoelectric semiconductor device according to the embodiment of the present invention described above with reference to FIGS. 6 and 11 is implemented using another method and configuration.

### MODES OF THE INVENTION

Hereinafter, a configuration and operation according to the present invention will be described in detail with reference to the accompanying drawings. In descriptions of the present invention with reference to the accompanying drawings, the same elements are denoted by the same reference numerals, and redundant description thereof will be omitted. It should be understood that, although the terms “first,” “second,” and the like may be used herein to describe various elements, the elements are not limited by the terms. The terms are only used to distinguish one element from another element.

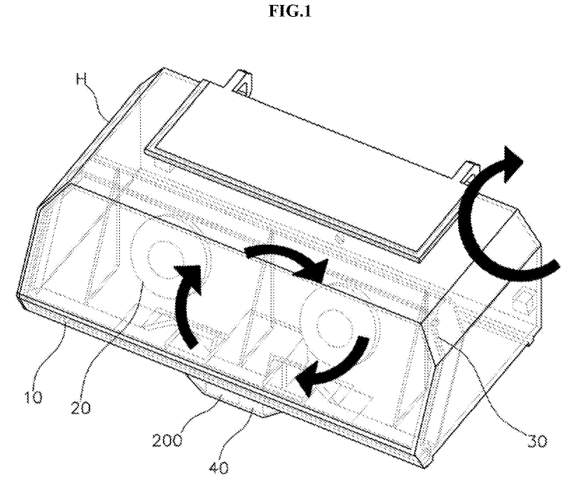

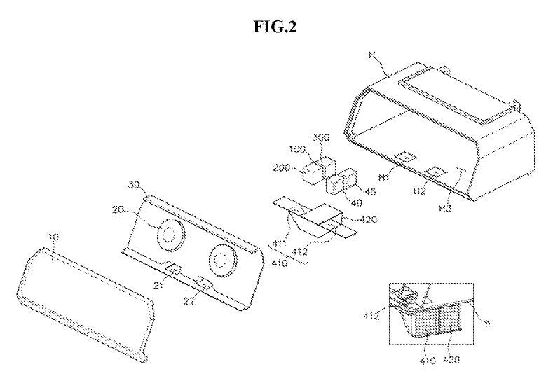

FIG. 1 is a conceptual cross-sectional view showing a structure of a vehicle lamp according to an embodiment of the present invention. Further, FIG. 2 is an exploded conceptual perspective view showing the structure of the vehicle lamp of FIG. 1.

Referring to FIGS. 1 and 2, the vehicle lamp according to the embodiment of the present invention may include a lens part 10, a light source part 20 spaced apart from the lens part, a bezel part 30 which is adjacent to the light source part 20 and provides a separation space D between the lens part 10 and the light source part, and a thermoelectric circulation part 400 which is disposed outside the bezel part and includes a thermoelectric module 100 including a plurality of thermoelectric semiconductor devices disposed between a first substrate and a second substrate facing each other. The thermoelectric circulation part 400 may enable air, which has passed through a first heat conversion member 200 on the thermoelectric module 200, to be introduced into the separation space.

Accordingly, a temperature inside the separation space D may be maintained at a temperature of a dew point or less so that moisture contained in the separation space may be controlled to be removed. Specifically, in this embodiment, the temperature of the first heat conversion member is maintained at a dew point or less by controlling a blowing module at a heat absorbing part of the thermoelectric module described above, so that the vehicle lamp may be driven using a method in which moisture contained in circulating air is condensed into a heat sink and is removed.

The lens part 10 may be an outer lens provided on an outermost side of a headlamp of a vehicle, and the lens part 10 is coupled to a housing of a lamp to form an overall exterior of the lamp. One light source part 20 or a plurality of the light source parts 20 may be provided to emit light to the outside through the lens part 10.

Specifically, in this case, the separation space D may be formed between the lens part 10 and the bezel part 30, and the separation space D may be formed in a closed structure to prevent air from being introduced from the outside and may have a structure in which humidity is easily adjusted by circulating air thereinside.

The light source part 20 is a concept encompassing a light emitting package including halogen lamps, high-intensity discharge (HID) lamps, or various solid light emitting devices such as light-emitting diodes (LEDs), laser diodes (LDs), and organic light-emitting diodes (OLEDs), and a structure including a structure of a reflective member or the like formed to be adjacent to a light emitting device. In addition, a lens member such as an inner lens may be additionally disposed in front of the light source part 20. When a light emitting device such as an LED or an LD is driven, the light source part 20 may inevitably generate heat, and the light source part 20 may further include a heat dissipation member for dissipating heat generated adjacent to the light emitting device to the outside.

An intermediate cover member, that is, the bezel part 30, is provided at a periphery of a light emitting surface of the light source part 20 for ensuring pleasing aesthetics inside the lamp and performing a function such as a reflection function. In this embodiment, the air heated while passing through the heat absorbing part (the first heat conversion member 200) of the thermoelectric module 100 may be supplied to the separation space D between a rear surface of the lens part 10 and the bezel part 30 so that a condensation phenomenon on a surface of the lens portion may be eliminated. The principle of eliminating the condensation phenomenon is that of a surface temperature of the first heat conversion member 200 being lowered to a dew point or less by cooling generated by an endothermic phenomenon of the heat absorbing part, moisture contained in the passing air is condensed on the surface of the first heat conversion member 200 to be removed in advance, and thus generation of condensation in the lens may be prevented.

To this end, in the structure shown in FIG. 1, the first heat conversion member 200 may be disposed on the second substrate in which the heat absorbing part of the thermoelectric module 100 is formed. A first blowing module 40 may be disposed behind the first heat conversion member 200 to guide air outside or inside the lamp into the first heat conversion member. The blowing module may include a blowing fan. Although not shown, the blowing module may include various components such as a power supply part for applying power to the first blowing module 40, circuit boards having a wiring part, and a controller, and the like. The first blowing module 40 may circulate the air inside the sealed space D, which is closed as described above, such that the air passes through the first heat conversion member 200 of the thermoelectric circulation part 400.

To this end, the thermoelectric circulation part 400 may include an accommodation member 410, which accommodates the thermoelectric module 100 and includes a first region 411 and a second region 412 which communicate with the inside of the separation space D, as shown in FIGS. 1 and 2. The accommodation member 410 has a structure in which the first region 411 and the second region 412 communicate with the inside of the separation space D, as shown in the drawings, so that the air inside the separation space D is circulated and passes through the first heat conversion member 200 in which the heat absorbing part is formed. To this end, as shown in the drawings, the first region 411 and the second region 412 which communicate with the inside of the separation space D may be respectively coupled and disposed to correspond to a first opening 21 and a second opening 22 which are formed at a lower portion of the bezel part 30. Accordingly, the air inside the separation space D may pass through only the first heat conversion member 200 on the heat absorbing part and may be circulated to the first region 411 and to the second region 412 via the separation space D. In this process, the air inside the separation space D is in contact with the surface of the first heat conversion member 200 having a temperature of a dew point or less due to an endothermic action, moisture contained therein is condensed, and the condensed moisture is removed by a periodic operation of the blowing fan.

On the other hand, the second heat conversion member 300, which forms the heat generating part, and the second blowing module 45 may be disposed in the side accommodation part 420 on a side surface of the accommodation member 410 of the thermoelectric circulation part 400, and may be disposed to correspond to openings H1 and H2 at a lower portion of the housing so as to communicate with an internal space H3 provided in the housing H. Accordingly, heat radiated through the housing H may be discharged to the outside.

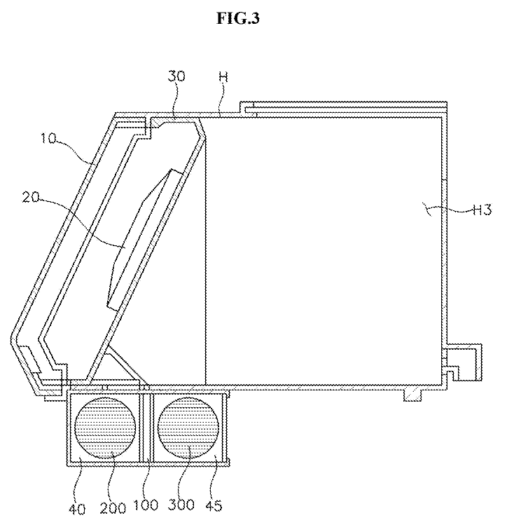

FIG. 3 is a conceptual perspective view of the vehicle lamp according to the embodiment of the present invention described in FIGS. 1 and 3.

Referring to FIGS. 1 to 3 described above, the separation space D is coupled to correspond to each of the first region 411 and the second region 412 of the thermoelectric circulation part 400 disposed below the bezel part 30 in which the first opening 21 and the second opening 22 are provided. When power is applied to the thermoelectric circulation part 400, the thermoelectric module operates and the heat absorbing part and the heat generating part are respectively formed on the second substrate and the first substrate by the Peltier effect. Specifically, the first heat conversion member 200 is disposed on the heat absorbing part formed on the second substrate, and the air inside the separation space D is circulated by an operation of the first blowing module 40 behind the first heat conversion member 200. In this case, moisture contained in the circulated air is condensed while in contact with the surface of the first heat conversion member 200 having a temperature of a dew point of the moisture or less due to an endothermic action, and the moisture condensed by the periodic air injection of the first blowing module is separated and removed downward. Accordingly, a condensation phenomenon occurring on an inner surface of the lens part 10 may be fundamentally removed.

Furthermore, heat remaining in the space inside the housing H is dissipated to the outside by the action of the second blowing module described above with reference to FIGS. 1 and 2.

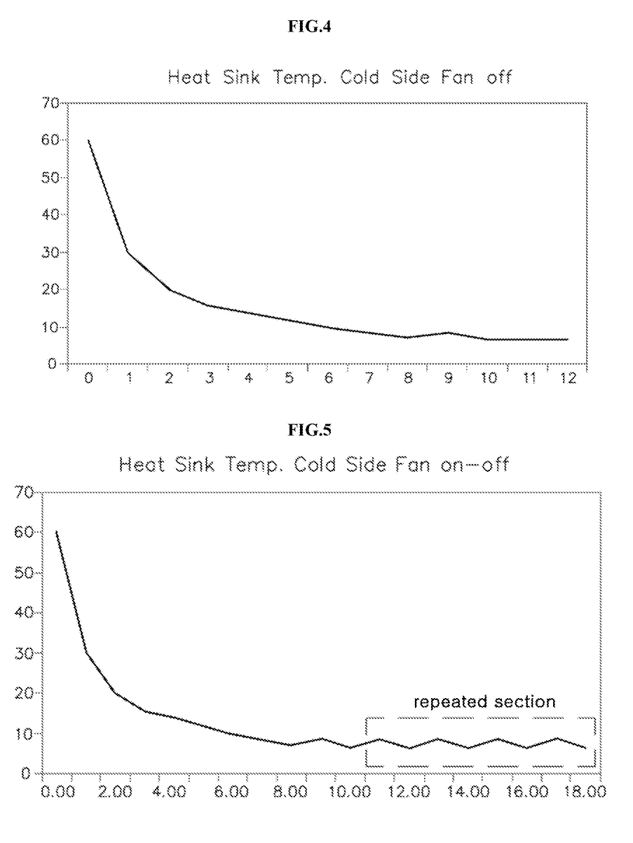

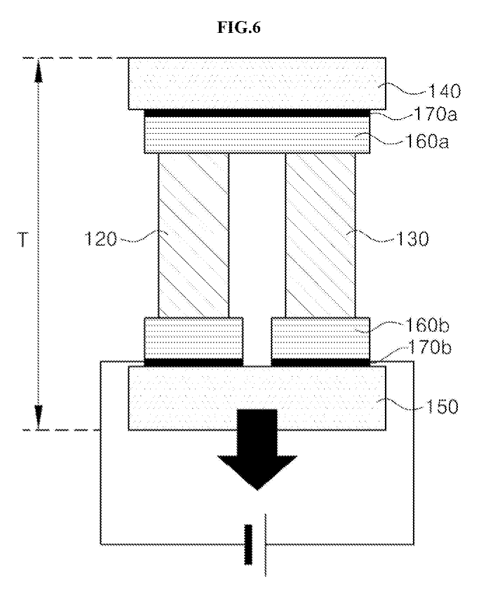

FIGS. 4 and 5 are experimental graphs for describing an embodiment of a control operation of the thermoelectric circulation part according to the embodiment of the present invention described above with reference to FIG. 3.

Referring to FIGS. 3 and 5, the thermoelectric circulation part 400 in the embodiment of the present invention described above may further include a controller (not shown) for controlling the driving of the first blowing module 45. In this case, the controller may control a driving cycle of the first blowing module to repeat an on period and an off period.

The graph in FIG. 4 shows a temperature change when the second blowing module of the second heat transfer member attached to the heat generating part (the first substrate) is always operated by applying power to the thermoelectric module of the present invention. In this case, it takes about 10 minutes for the temperature of the first heat transfer member of the heat absorbing part to drop to the lowest temperature (6.6° C.). On the other hand, here, when the first blowing module adjacent to the first heat transfer member attached to the second substrate (the heat absorbing part) is operated, the temperature of the heat absorbing part is raised to 8.6° C., the blowing fan of the first blowing module is stopped, and then the temperature reaches the minimum temperature again after 2 seconds.

Therefore, in the embodiment of the present invention, as shown in FIG. 5, the control mechanism of the controller may be implemented so that the driving cycle of the first blowing module in the on period is shorter than in the off period. That is, the first blowing module of the heat absorbing part is stopped and only the second blowing module is operated during initial driving, the first blowing module is turned on for 2 seconds after 10 minutes, the temperature of the first heat conversion member is maintained low by repeating a 118 seconds (off) period at regular intervals, water droplets condensed on the surface of the first heat conversion member are instantaneously blown, and thus performance reduction due to the condensed water droplets may be prevented. A gradient of the off period described above is an example, and it is needless to say that the gradient may be variously set.

Furthermore, the heat generating part may be formed on the first substrate facing the second substrate of the thermoelectric module 100. As shown in FIG. 1, the second heat conversion member 300 may be disposed on the first substrate and the second blowing module 45 may be disposed to be adjacent to the second heat conversion member. The heat inside the housing may be discharged to the outside by the mechanism of the second blowing module 45.

Hereinafter, various embodiments of the thermoelectric module applied to the vehicle lamp according to the embodiment of the present invention described above will be described.

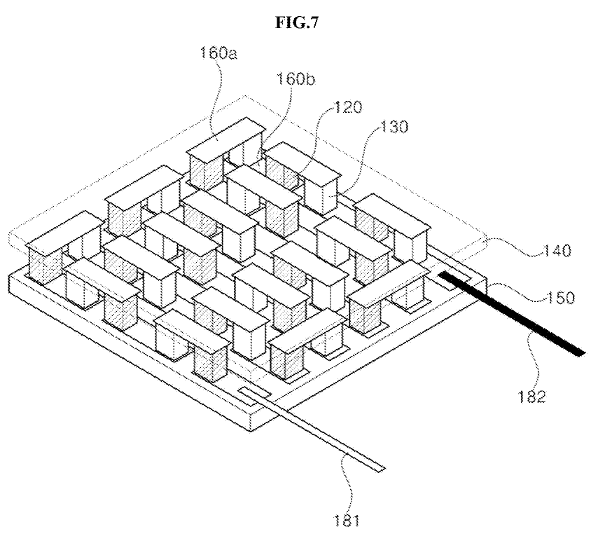

FIG. 6 is a cross-sectional view showing a main part of a thermoelectric module according to an embodiment of the present invention applied to the vehicle lamp described above with reference to FIGS. 1 to 3, and FIG. 7 is a view showing an example in which a structure of FIG. 6 is modularized and expanded.

Referring to FIG. 6, a thermoelectric module 100 applied to the vehicle lamp according to the embodiment of the present invention has a structure in which a first semiconductor device 120 and a second semiconductor device 130 are disposed between a first substrate 140 and a second substrate 150 facing the first substrate 140. Specifically, a first heat conversion member 200 which performs a heat generating function may be disposed on the first substrate 140 to perform a heat generating operation, and a first heat conversion member 200 which performs a heat absorbing function may be disposed on the second substrate 150 to perform a cooling function. As described above with reference to FIGS. 1 to 3, the first heat conversion member 200 may be disposed on the second substrate 150 to perform a heat absorbing function as described above.

In the thermoelectric module 100, an insulating substrate such as an alumina substrate may be used as the first substrate 140 and the second substrate 150. In another embodiment, the first substrate 140 and the second substrate 150 may be implemented using a metal substrate to achieve heat absorption efficiency, heat generation efficiency, and thinness. Of course, when the first substrate 140 and the second substrate 150 are formed of a metal substrate, dielectric layers 170a and 170b are preferably formed between electrode layers 160a and 160b formed on the first and second substrates 140 and 150, respectively, as shown in FIG. 6.

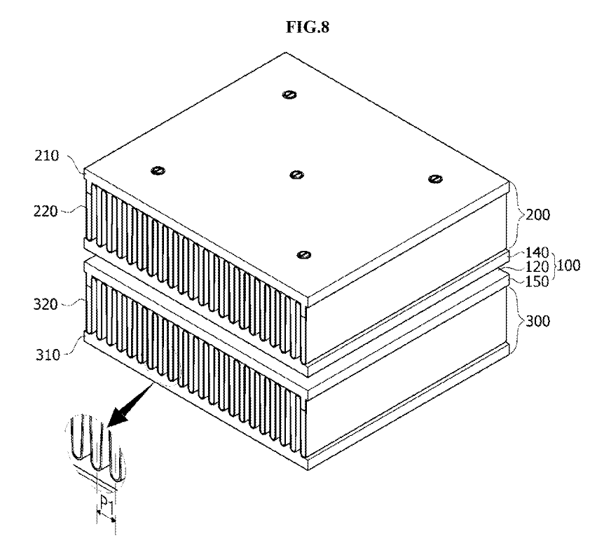

In the case of the metal substrate, Cu or a Cu alloy may be used, and a thickness of the metal substrate, which is capable of being made thin, may be formed in a range of 0.1 mm to 0.5 mm. When the thickness of the metal substrate is less than 0.1 mm or is more than 0.5 mm, the reliability of the thermoelectric module is significantly reduced because a heat radiation characteristic is too high or the thermal conductivity is too high. Further, in the case of the dielectric layers 170a and 170b, in consideration of the thermal conductivity of a cooling thermoelectric module as a dielectric material having high heat dissipation performance, a material having a thermal conductivity of 5 to 10 W/K may be used and a thicknesses of the material may be in a range of 0.01 mm to 0.15 mm. In this case, when the thickness of the material is less than 0.01 mm, insulation efficiency (or a withstand voltage characteristic) is significantly reduced. When the thickness of the material is more than 0.15 mm, the thermal conductivity is lowered and the heat radiation efficiency is lowered. The electrode layers 160a and 160b electrically connect the first semiconductor device and the second semiconductor device using an electrode material such as Cu, Ag, Ni, or the like, and when a plurality of unit cells are connected, the plurality of unit cells are electrically connected to adjacent unit cells as shown in FIG. 7. The electrode layer may be formed to have a thickness of 0.01 mm to 0.3 mm. When the thickness of the electrode layer is less than 0.01 mm, functionality as an electrode of the electrode layer is lowered, and even when the thickness of the electrode layer is more than 0.3 mm, conduction efficiency is lowered due to an increase in resistance.

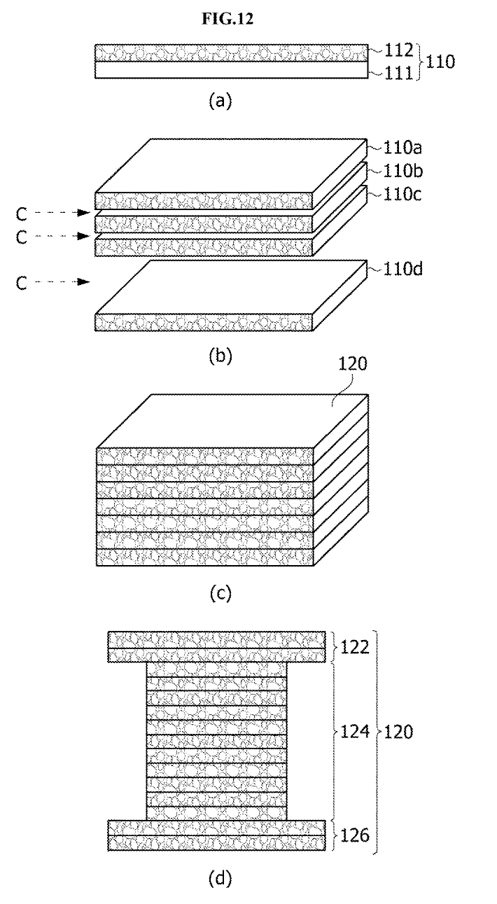

FIG. 7 is a view of a structure in which the plurality of unit cells (each formed of a pair of thermoelectric semiconductor devices) having the structure of FIG. 6 are connected and modularized. In particular, in this case, a thermoelectric element including unit elements having a stacked structure as shown in FIG. 11 may be applied to the thermoelectric element constituting a unit cell described below. In this case, one of the pair of thermoelectric semiconductor devices may be formed of a P-type semiconductor as the first semiconductor device 120 and the other thereof may be formed of an N-type semiconductor as the second semiconductor device 130, and the first semiconductor device and the second semiconductor device are connected to the metal electrode layers 160a and 160b. A plurality of such structures are formed, and the Peltier effect is realized by circuit lines 181 and 182 through which a current is supplied to the semiconductor devices via the electrodes.

A P-type semiconductor or an N-type semiconductor material may be applied to the semiconductor device in the thermoelectric module. In such a P-type semiconductor or N-type semiconductor material, the N-type semiconductor device may be formed using a main raw material made of bismuth telluride (BiTe-based) containing selenium (Se), nickel (Ni), aluminum (Al), copper (Cu), silver (Ag), lead (Pb), boron (B), gallium (Ga), tellurium (Te), bismuth (Bi), and indium (In), and a mixture of Bi or Te corresponding to 0.001 to 1.0 wt % of a total weight of the main raw material. For example, the main raw material may be a Bi—Se—Te material, Bi or Te having a weight corresponding to 0.001 to 1.0 wt % of the total weight of Bi—Se—Te may be further added to the Bi—Se—Te, and thus the N-type semiconductor device may be formed. That is, when 100 g of Bi—Se—Te is added, Bi or Te, which is further added, is preferably introduced in a range of 0.001 g to 1.0 g. As described above, when a weight range of the material added to the above-described main raw material is out of a range of 0.001 wt % to 0.1 wt %, the thermal conductivity is not lowered, the electric conductivity is lowered, and the improvement of a ZT value may not be expected.

The P-type semiconductor material may preferably be formed using a main raw material made of antimony (Sb), nickel (Ni), aluminum (Al), copper (Cu), silver (Ag), lead (Pb), boron (B), gallium (Ga), tellurium (Te), bismuth (Bi), and indium (hi), and a mixture of Bi or Te corresponding to 0.001 to 1.0 wt % of a total weight of the main raw material. For example, the main raw material may be a Bi—Sb—Te material, Bi or Te having a weight corresponding to 0.001 to 1.0 wt % of the total weight of Bi—Sb—Te may be further added to the Bi—Se—Te, and thus the P-type semiconductor device may be formed. That is, when 100 g of Bi—Sb—Te is added, Bi or Te, which is further added, is preferably introduced in a range of 0.001 g to 1 g. When a weight range of the material added to the above-described main raw material is out of a range of 0.001 wt % to 0.1 wt %, the thermal conductivity is not lowered, the electric conductivity is lowered, and the improvement of a ZT value may not be expected.

Shapes and sizes of the first semiconductor device and the second semiconductor device which form a unit cell and face each other are the same. However, in this case, the electrical conductivity of the P-type semiconductor device and the electrical conductivity of the N-type semiconductor device are different from each other, and in consideration of acting as an element for hindering the cooling efficiency, it is also possible to make the volume of one semiconductor device different from the volume of other semiconductor devices facing each other so as to improve the cooling performance.

That is, different volumes may be formed for the semiconductor devices of the unit cell disposed to face each other by forming the entire shape differently, by forming a wider diameter for either one of semiconductor devices having the same height, or by forming different heights or diameters for cross sections of semiconductor devices having the same shape. Specifically, the N-type semiconductor device is formed to have a diameter greater than that of the P-type semiconductor device, the volume of the N-type semiconductor device may be increased, and thus the thermoelectric efficiency may be improved.

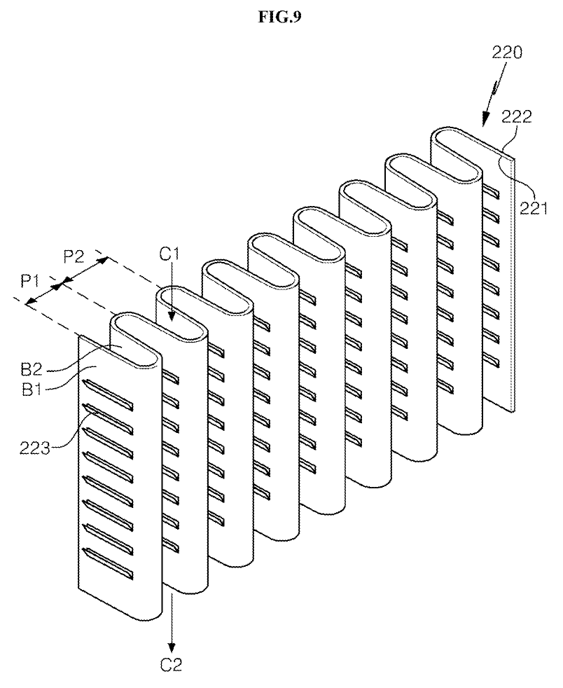

FIG. 8 is a view showing various embodiments of the heat conversion member according to the embodiment of the present invention.

In the first heat conversion member and the second heat conversion member according to the embodiment of the present invention of FIGS. 1 to 3, a fin structure or a structure in which a plurality of thin plate structures are disposed may be applied to a radiating fin on the base substrate. Furthermore, a structure having a curvature may be applied to a shape of the heat conversion member in an embodiment in which heat generation or cooling efficiency may be maximized as shown in FIG. 8.

Referring to FIG. 8, FIG. 8 shows a structure including a first heat conversion member 200 disposed on the thermoelectric module 100 and a second heat conversion member 300 disposed below the thermoelectric module 100 including thermoelectric semiconductor devices between a pair of substrates. The first heat conversion member 200 and the second heat conversion member 300 may achieve heat conversion with incoming air or exhausted air using the thermoelectric effect realized using the first substrate 140 and the second substrate 150 of the thermoelectric module 100.

Specifically, the first heat conversion member 200 may be disposed on the second substrate 150 to form a heat absorbing part for achieving an endothermic effect, and may be disposed in an air circulation path along the thermoelectric circulation part 400, as described above with reference to FIGS. 1 and 2.

Like the structure shown in FIG. 8, the first heat conversion member 200 and the second heat conversion member 300, which achieve a heat absorbing function, may have a structure in which the first heat conversion member 200 and the second heat conversion member 300 are in direct contact with the first substrate 140 and the second substrate 150, respectively, or may be formed in a structure in which the first heat conversion member 200 and the second heat conversion member 300 are respectively disposed in separate accommodating modules 210 and 310.

FIG. 9 is a view showing in detail the structure of the first heat conversion member 200 according to the embodiment of the present invention described above with reference to FIG. 8, and FIG. 9 is an enlarged conceptual view of a structure in which one flow path pattern 220A is formed in the first heat conversion member 200. The same structure as the above structure may also applied to the structure of the second heat conversion member 300 on the first substrate 140. Therefore, hereinafter, the structure of the first heat conversion member 200 will be mainly described.

As shown in FIG. 9, the first heat conversion member 200 may be formed to have a structure in which at least one flow path pattern 220A which forms an air flow path C1, which is a constant movement path of air, is formed on the base substrate having a flat plate shape having a first plane 221 and a second plane 222 opposite the first plane 221 so as to create surface contact with the air.

The flow path pattern 220A may be formed to have a structure in which the base substrate is folded so that a curvature pattern having constant pitches P1 and P2 and height T1 is formed, that is, a folding structure, as shown in FIG. 9. That is, heat conversion members 220 and 320 according to the embodiment of the present invention may have a structure in which two surfaces are allowed to be in surface contact with the air and a flow path pattern is formed to maximize a surface area to be contacted.

In the structure shown in FIG. 9, when air is introduced from a flow path direction C1 of an inflow portion into which the air is introduced, the air is uniformly in contact with the first plane 221 and the second plane 222, which is an opposite surface of the first plane 221 described above, is moved, and proceeds in a flow path direction C2. Therefore, it is possible to induce much more air contact in the same space than with a contact surface with a simple flat plate shape, and an effect of heat absorption or heat generation is further improved.

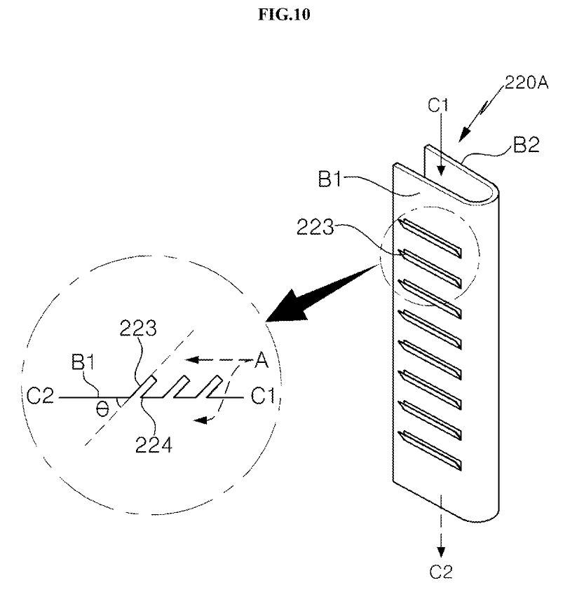

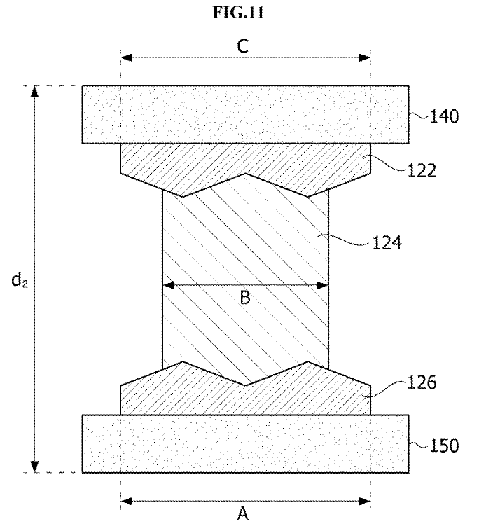

Specifically, in order to further increase a contact area with the air, the heat conversion member 220 according to the embodiment of the present invention may include a resistance pattern 223 on a surface of the base substrate, as shown in FIGS. 9 and 10. The resistance pattern 223 may be formed on each of a first curved surface B1 and a second curved surface B2 in consideration of a unit flow path pattern. The resistance pattern may have a structure which protrudes in the direction of either the first plane or the second plane opposite the first plane. Furthermore, the first heat conversion member 200 may further include a plurality of fluid flow grooves 224 passing through the surface of the base substrate. Accordingly, the air contact and movement may be freely achieved between the first plane and the second plane of the heat conversion member 240.

Specifically, like the partially enlarged view in FIG. 10, the resistance pattern 224 may be formed as a protruding structure inclined so as to have an inclination angle θ in a direction into which the air is introduced, friction with the air may be maximized, and thus the contact area or contact efficiency may be further increased. The inclination angle θ is more preferably an acute angle between a horizontal extension line of the resistance pattern surface and an extension line of the surface of the base substrate, and this is because a resistance effect is reduced when the angle is right or obtuse. In addition, the flow grooves 224 are disposed in the resistance pattern and the connection part of the base substrate, and thus the resistance of a fluid such as air may be increased and movement to the opposite surface may be made efficient. Particularly, the flow grooves 224 are formed on the surface of the base substrate in a front portion of the resistance pattern 223 to allow some of the air which comes in contact with the resistance pattern 223 to pass through a front surface and a rear surface of the base substrate, and thus a contact frequency and a contact area may be further increased.

In FIG. 10, the flow path pattern is shown as being formed to have a structure having a constant pitch as a periodical constant interval. However, a pitch of a unit pattern may be deformed to be non-uniform and so that a periodicity of the pattern may be irregularly implemented. Furthermore, a height T1 of each unit pattern may also be non-uniformly deformed.

In FIGS. 8 to 10, a structure in which one first heat conversion member included in the thermal conversion module is included in a heat transfer device according to the embodiment of the present invention is described. However, in another embodiment, a structure in which a plurality of thermal conversion members are stacked in one heat transfer module may be implemented. Accordingly, a contact surface area with the air may be further maximized, such that a structure may be implemented as a structure in which many contact surfaces may be implemented in a narrow area due to a specific property of the heat conversion member of the present invention formed by a folding structure, and thus a larger number of heat conversion members may be disposed in the same volume. Of course, in this case, a supporting substrate such as a second intermediate member or the like may be further disposed between the heat conversion members stacked one on top of the other. Furthermore, in still another embodiment of the present invention, a structure in which two or more thermoelectric modules are included therein may be implemented.

Further, a pitch of the first heat conversion member of the thermoelectric module (the first substrate) which forms the heat generating part and a pitch of the second heat conversion member of the thermoelectric module (the second substrate) which forms the heat absorbing part may be formed to be different from each other. In this case, specifically, the pitch of the flow path pattern of the heat conversion member in the heat conversion module which forms the heat generating part may be formed to be greater than or equal to the pitch of the flow path pattern of the heat conversion member in the heat conversion module which forms the heat absorbing part. In this case, a ratio of the pitch of the first heat conversion member of the first heat conversion member to the pitch of the flow path pattern of the first heat conversion member of the second heat conversion member may be in a range of (0.5 to 2.0):1.

The structure of the heat conversion member according to the embodiment of the present invention which forms the flow path pattern may have a much larger contact area within the same volume than a heat conversion member having a flat plate structure or an existing heat dissipation fin structure, and thus the air contact area of 50% or more of the heat conversion member having the flat plate structure may be increased so that a size of the module may be significantly reduced. In addition, various members such as a metal material having high heat transfer efficiency such as aluminum, a synthetic resin, and the like may be applied to such a heat conversion member.

Hereinafter, a modified embodiment, in which the shape of the thermoelectric semiconductor device included in the thermoelectric module 100 applied to the vehicle lamp structure of the embodiment of FIGS. 1 to 3 is changed and heating efficiency is increased, will be described.

That is, a deformed shape of the thermoelectric semiconductor device of FIG. 11 may be applied to a unit structure of the thermoelectric module of FIG. 6. Referring to FIGS. 6 and 11, a thermoelectric element 120 according to another modified embodiment of the present invention may have a structure including a first device 122 having a first cross-sectional area, a second device 126 which has a second cross-sectional area and is disposed at a position facing the first device 122, and a connection part 124 which has a third cross-sectional area and connects the first device 122 to the second device 126. Specifically, in this case, a cross-sectional area in an arbitrary area in a horizontal direction of the connection part 124 may be smaller than the first cross-sectional area and the second cross-sectional area.

When the same amount of the same material as a thermoelectric element having a single cross-sectional area such as that of a cubic structure is applied, areas of the first device and the second device may be widened and a length of the connection portion may be made long, and thus a temperature difference AT between the first device and the second device may be advantageously increased. When the temperature difference is increased, an amount of free electrons moving between a hot side and a cold side increases, such that an electric power generation amount increases, and in the case of heat generation or cooling, the efficiency thereof increases.

Therefore, in the thermoelectric element 120 according to this embodiment, the first device and the second device have a flat plate structure or another three-dimensional structure on an upper portion and a lower portion of the connection part 124 and may have wide horizontal cross-sectional areas, and a length of the connection part may be increased to reduce a cross-sectional area of the connection part. Specifically, in the embodiment of the present invention, a ratio of a width B of a cross section having the longest width among horizontal cross sections of the connection part to a width A or C of a larger cross section among horizontal cross sections of the first device and the second device may be in a range which satisfies a range of 1:(1.5 to 4). When the ratio is out of this range, the heat is conducted from the heat generation side to the cooling side, and the power generation efficiency is lowered or the heat generation or cooling efficiency is lowered.

In another aspect of the embodiment of the structure, in the thermoelectric element 120, thicknesses a1 and a3 in a longitudinal direction of the first device and the second device may be smaller than a longitudinal thickness s2 of the connection part.

Furthermore, in this embodiment, the first cross-sectional area, which is a cross-sectional area in a horizontal direction of the first device 122, and the second cross-sectional area, which is a cross-sectional area in a horizontal direction of the second device 126, may be different from each other. This is for easily controlling a desired temperature difference by controlling the thermoelectric efficiency. Furthermore, the first device, the second device, and the connection part may be integrally formed with each other. In this case, the respective components may be formed of the same material.

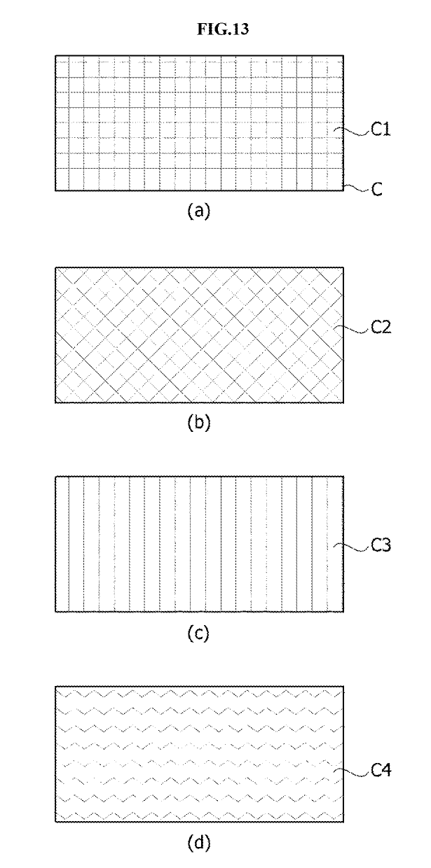

FIG. 12 is a view showing an example in which the structure of the thermoelectric semiconductor device according to the embodiment of the present invention described above with reference to FIGS. 6 and 11 is implemented using another method and configuration.

Referring to FIG. 12, in still another embodiment of the present invention, the above-described semiconductor device may have a stacked structure rather than a bulk structure, so that the thinning and cooling efficiency may be further improved. Particularly, the structures of the first semiconductor device 120 and the second semiconductor device 130 in FIG. 6 or 11 may be formed as a unit member in which a plurality of structures coated with a semiconductor material are stacked on a sheet-shaped base substrate, and then the unit member is cut to prevent loss of the material and improve an electrical conduction characteristic.

Referring to FIG. 12, FIG. 12 is a conceptual diagram showing a process of manufacturing a unit member having the above-described stacked structure. Referring to FIG. 12, a material including a semiconductor material is prepared in a paste form and the paste is applied on a base substrate 111 such as a sheet, a film, or the like to form a semiconductor layer 112 so that one unit member 110 is formed. The unit member 110 is formed by stacking a plurality of unit members 100a, 100b, and 100c to form a stacked structure, and then the stacked structure is cut to form a unit thermoelectric element 120, as shown in FIG. 12. That is, the unit thermoelectric element 120 according to the present invention may be formed to have a structure in which a plurality of unit members 110 in which the semiconductor layer 112 is stacked are stacked on the base substrate 111.

The process of applying the semiconductor paste on the substrate 111 in the above-described process may be performed using various methods. For example, a slurry may be prepared by tape casting, that is, mixing a very fine semiconductor material powder, with any one selected from the group consisting of a water-based or non-aqueous solvent, a binder, a plasticizer, a dispersant, a defoamer, and a surfactant, and then a process of molding may be performed to form a desired constant thickness on a moving blade or moving transfer base substrate. In this case, a material such as a film, a sheet, or the like having a thickness in a range of 10 μm to 100 μm may be used as the base substrate, and a P-type material and an N-type material for preparing the above-described bulk type semiconductor material may be applied as they are.

In a process of aligning and stacking the unit member 110 in multiple layers, the unit members 110 are formed to have a stacked structure by pressing at a temperature of 50° C. to 250° C. In the embodiment of the present invention, the number of stacked unit members 110 may be in a range of 2 to 50. Then, a process of cutting to a desired shape and size may be performed, and a sintering process may be additionally performed.

The unit thermoelectric elements in which a plurality of unit members 110 manufactured according to the above-described processes are stacked may secure uniformity of thickness and configuration size. That is, conventional bulk type thermoelectric elements are cut into a sintered bulk structure after ingot milling and finishing ball-mill processes, such that a large amount of material is lost in the cutting process and it is difficult to cut into a uniform size, and it is difficult to reduce the thickness because the thickness is as large as about 3 mm to 5 mm. However, since the unit thermoelectric element having a stacked structure according to the embodiment of the present invention cuts the stacked sheet material after the sheet-shaped unit members are stacked in multiple layers, there is almost no material loss and the material has a uniform thickness, and thus uniformity of the material may be ensured. A total thickness of the unit thermoelectric element may be reduced to 1.5 mm or less, and various shapes may be implemented.

A finally implemented structure may be cut into the shape of FIG. 12D, as in the structure of FIG. 6 or the structure of the thermoelectric element according to the embodiment of the present invention described above with reference to FIG. 11. Specifically, in the manufacturing process of the unit thermoelectric element according to the embodiment of the present invention, a process of forming a conductive layer on the surface of each unit member 110 in a process of forming a stacked structure of the unit member 110 may be further included.

That is, the same conductive layer as the structure of FIG. 12 may be formed between the unit members of the stacked structure of FIG. 12C. The conductive layer may be formed on an opposite surface of the base substrate surface on which the semiconductor layer is formed. In this case, a patterned layer may be formed such that a region of a surface of the unit member is exposed. This makes it possible to increase the electrical conductivity and to improve the bonding force between the respective unit members, and the thermal conductivity may be lowered, as compared to the case in which the entire surface is coated.

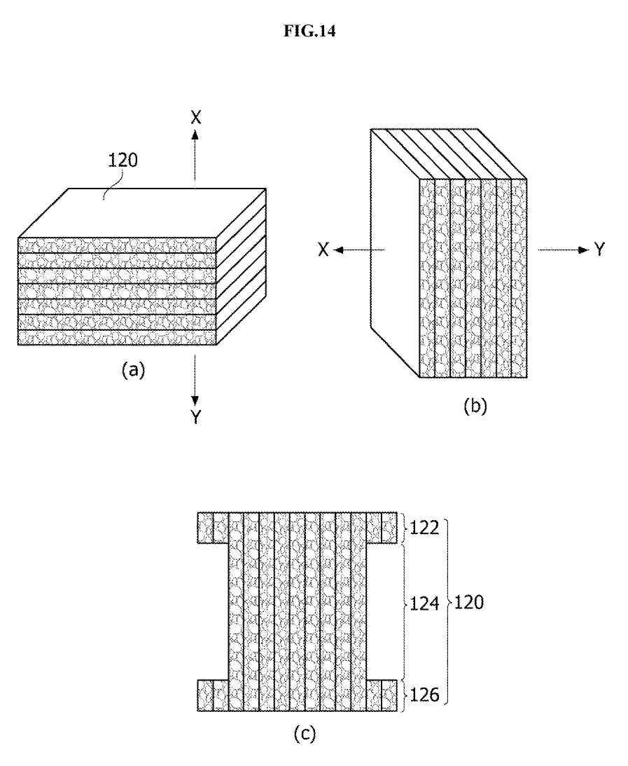

That is, FIG. 13 shows various modified examples of a conductive layer C according to an embodiment of the present invention. The pattern in which the surface of the unit member is exposed may be designed by being variously changed into a mesh type structure including closed type opening patterns c1 and c2, as shown in FIGS. 13A and 13B, or a line type structure including open type opening patterns c3 and c4, as shown in FIGS. 13C and 13D. The above conductive layer is advantageous in that it may improve the adhesive force between the unit members in the unit thermoelectric element formed by the stacked structure of the unit members, lower the thermal conductivity between the unit members, and improve the electric conductivity. Cooling capacity Qc and ΔT (° C.) are improved in comparison to the conventional bulk type thermoelectric element, and a power factor, that is, the electric conductivity, is increased 1.5 times. The increase of the electrical conductivity is directly related to the improvement of the thermoelectric efficiency, and thus the cooling efficiency is improved. The conductive layer may be formed of a metal material, and all of electrode materials of a metal-based material such as Cu, Ag, Ni, or the like may be implemented.

When the unit thermoelectric element having a stacked structure described above with reference to FIG. 12 is applied to the thermoelectric modules shown in FIGS. 6 and 7, that is, when the thermoelectric module according to the embodiment of the present invention is disposed between the first substrate 140 and the second substrate 150 and the thermoelectric module is implemented as a unit cell having a structure including an electrode layer and a dielectric layer, a total thickness Th may be formed in a range of 1.0 mm to 1.5 mm, which makes it possible to achieve significant thinness compared to the case in which a conventional bulk type element is used. In this case, when an apparatus for removing the condensation of the vehicle lamp according to the embodiment of the present invention described above with reference to FIGS. 1 to 3 is implemented, it may be effectively utilized in a limited space.

Further, as shown in FIG. 14, the thermoelectric elements 120 and 130 described above with reference to FIG. 8 may be aligned in order to be horizontally disposed in an upper direction X and a lower direction Y and cut as shown in FIG. 14C to implement the thermoelectric element according to the embodiment of the present invention.

That is, the thermoelectric module may be formed to have a structure in which the first substrate and the second substrate are disposed to be adjacent to the semiconductor layer and the surface of the base substrate. However, as shown in FIG. 14B, the thermoelectric element itself may be vertically erected so that the side surfaces of the unit thermoelectric elements are disposed to be adjacent to the first and second substrates. In such a structure, an end portion of the conductive layer may be exposed to the side surface rather than a horizontally arranged structure, and thus heat conduction efficiency in a vertical direction may be lowered and an electrical conduction characteristic may be improved, such that cooling efficiency may be further improved. Furthermore, the shape of FIG. 8 may be cut and applied as shown in FIG. 14C.

As described above, in the thermoelectric element applied to the thermoelectric module of the present invention which may be implemented in various embodiments, shapes and sizes of the first semiconductor device and the second semiconductor device which face each other are the same. However, in this case, the electrical conductivity of the P-type semiconductor device and the electrical conductivity of the N-type semiconductor device are different from each other, and in consideration of acting as a factor for hindering cooling efficiency, it is also possible to make the volume of one semiconductor device different from the volume of other semiconductor devices facing each other so as to improve the cooling performance.

That is, different volumes may be formed for the semiconductor devices disposed to face each other by forming the entire shape very differently, by forming a wider diameter for either one of semiconductor devices having the same height, or by forming different heights or diameters for cross sections of semiconductor devices having the same shape. Specifically, the N-type semiconductor device is formed to have a diameter greater than that of the P-type semiconductor device, the volume thereof may be increased, and thus the thermoelectric efficiency may be improved.

While embodiments of the preset invention have been described above in detail, it should be understood by those skilled in the art that the embodiments may be variously modified without departing from the scope of the present invention. Therefore, the scope of the present invention is defined not by the described embodiment but by the appended claims, and encompasses equivalents that fall within the scope of the appended claims.

1. A vehicle lamp comprising:
a lens part;
a light source part spaced apart from the lens part;
a bezel part which is adjacent to the light source part and provides a separation space between the lens part and the light source part; and
a thermoelectric circulation part which is disposed outside the bezel part and includes a thermoelectric module including a plurality of thermoelectric semiconductor devices disposed between a first substrate and a second substrate facing each other,
wherein the thermoelectric circulation part enables air, which has passed through a first heat conversion member on the thermoelectric module, to be introduced into the separation space.

2. The vehicle lamp of claim 1, wherein the thermoelectric circulation part includes an accommodation member configured to accommodate the thermoelectric module and including a first region and a second region which communicate with an inside of the separation space.

3. The vehicle lamp of claim 2, wherein the thermoelectric circulation part circulates the air, which has passed through the first heat conversion member, to the first region and to the second region via the separation space.

4. The vehicle lamp of claim 2, wherein the first heat conversion member is disposed on the second substrate which forms a heat absorbing region.

5. The vehicle lamp of claim 4, wherein the thermoelectric circulation part further includes a second thermoelectric circulation member disposed on the first substrate which forms a heat generating region.

6. The vehicle lamp of claim 5, wherein:
the vehicle lamp further includes a housing coupled to a rear of the lens part and the bezel part; and
the second thermoelectric circulation member of the thermoelectric circulation part communicates with an inside of the housing.

7. The vehicle lamp of claim 1, wherein the thermoelectric circulation part further includes a first blowing module configured to flow air to the first heat conversion member.

8. The vehicle lamp of claim 7, wherein the thermoelectric circulation part further includes a controller configured to control driving of the first blowing module.

9. The vehicle lamp of claim 8, wherein the controller controls a driving cycle of the first blowing module to repeat an on period and an off period.

10. The vehicle lamp of claim 9, wherein the driving cycle of the first blowing module in the on period is shorter than that in the off period.

11. The vehicle lamp of claim 7, wherein the separation space between the lens part and the bezel part has a structure in which a space other than a space which communicates with the thermoelectric circulation part is closed.

12. The vehicle lamp of claim 7, wherein in the first heat conversion member, at least one flow path pattern, which is a path of air, is provided on base substrates of a first plane and a second plane opposite the first plane in a form of a flat plate so that surface contact with air is created.

13. The vehicle lamp of claim 12, wherein the flow path pattern has a structure in which a curvature pattern having constant pitches P1 and P2 and a height T1 is repeatedly provided.

14. The vehicle lamp of claim 7, wherein the first heat conversion member has a pin type structure including a plurality of heat conversion patterns protruding from a base substrate.

15. The vehicle lamp of claim 2, wherein the bezel part includes a first opening and a second opening, and
wherein the first region and the second region are coupled to correspond to the first opening and the second opening respectively and communicate with the inside of the separation space.

16. The vehicle lamp of claim 9, wherein the controller controls the driving cycle of the first blowing module to maintain the temperature of the first heat conversion member at a dew point or less.

17. The vehicle lamp of claim 6, wherein the thermoelectric circulation part further includes a second blowing module disposed to be adjacent to the second thermoelectric circulation member.

18. The vehicle lamp of claim 17, the second blowing module and the second thermoelectric circulation member are disposed in a side accommodation part of the accommodation member.

19. The vehicle lamp of claim 18, wherein the side accommodation part of the accommodation member disposed to correspond to openings at a lower portion of the housing so as to communicate with an internal space provided in the housing.

20. The vehicle lamp of claim 19, wherein the second blowing module discharge a heat inside the housing to an outside of the housing.
